(19) United States
(12) Patent Application Publication
(10) Pub. No.: US 2011/0100542 A1
(43) Pub. Date: May 5, 2011

(54) METHOD AND MANUFACTURING MOLD FOR THE PRODUCTION OF A ROTOR BLADE FOR A WIND TURBINE

(75) Inventors: Benn Faulkner, Ningwood Isle of Wight (GB); Enno Eyb, Kiel (DE); Christoph Hofmann, Bremen (DE)

(73) Assignees: REPOWER SYSTEMS AG, Hamburg (DE); POWERBLADES GMBH, Bremerhaven (DE)

(21) Appl. No.: 13/000,142

(22) PCT Filed: Jun. 22, 2009
(86) PCT No.: PCT/EP2009/004478

§ 371 Date: Dec. 20, 2010

(30) Foreign Application Priority Data
Jun. 27, 2008 (DE) 102008030132.9
Jul. 31, 2008 (DE) 102008035588.7
Aug. 12, 2008 (DE) 102008038620.0

(51) Int. Cl. B29C 70/30; B29C 33/00; B29C 33/20

(52) U.S. Cl. 156/245; 425/470; 425/451.9

(57) ABSTRACT

A manufacturing mold for the production of a rotor blade for a wind turbine, where at least in one region of its longitudinal extension between a rotor blade root and a rotor blade tip, the finished rotor blade has an aerodynamic cross-sectional profile that has a profile leading edge (nose) and a profile trailing edge which are connected together via a suction side and a pressure side of the cross-sectional profile. A manufacturing mold can be divided along at least one separation plane which extends in the longitudinal direction of the rotor blade and between the profile leading edge and the profile trailing edge while simultaneously dividing the suction side and the pressure side, into a manufacturing mold part for producing a rotor blade part having the profile leading edge, and into a manufacturing mold part for producing a rotor blade profile part having the profile trailing edge.

### BACKGROUND OF THE INVENTION

1. Field of the Invention

The invention relates to a manufacturing mold for the production of a rotor blade for a wind turbine, where the finished rotor blade has at least in a region of its longitudinal extension between a rotor blade root and a rotor blade tip, an aerodynamic cross-sectional profile that has a profile leading edge (nose) and a profile trailing edge which are connected together via a suction side and a pressure side of the cross-sectional profile.

In addition, the invention relates to a method for producing a rotor blade for a wind turbine.

2. Description of Related Art

A generic manufacturing mold is known, for example, from WO2004/043679.

The object of the invention is to improve a divided production of a rotor blade in order to facilitate the handling of the manufacturing mold and such that, at the same time, the quality of the rotor blade produced from this simplification remains unaffected.

### BRIEF SUMMARY OF THE INVENTION

This object is solved according to the invention in that the manufacturing mold can be divided along at least one separation plane which extends in the longitudinal direction of the rotor blade and between the profile leading edge and the profile trailing edge, simultaneously dividing the suction side and the pressure side, and can be divided into a manufacturing mold part for producing a rotor blade part comprising the profile leading edge and a manufacturing mold part for producing a rotor blade profile part comprising the profile trailing edge.

According to the invention, the division of the manufacturing mold is substantially orthogonal to the division of the known manufacturing mold mentioned further above. This results in advantages for the separation process of the manufacturing molds and for joining, wherein the finished rotor blade can also have advantages because in each case the profile trailing edge and the profile leading edge can be manufactured as a whole.

Here, the separation surface is preferably oriented approximately perpendicularly so that the profile remains in a flat orientation. Thereby, the manufacturing mold parts can be advantageously slid apart and together again on the same plane. However, it is also conceivable to produce the profile so that the profile produced is oriented on edge or upright, wherein the manufacturing mold parts for their separation can be lifted off each other and/or pivoted. Perpendicular is understood to be vertical. Approximately perpendicular means, in particular, up to ±15° from vertical, preferably vertical.

A further development of the invention is characterized in that at least one of the manufacturing mold parts can, for its part, be divided.

This advantageously further facilitates the handling of the forms and the production of the rotor blade through segmenting, again, without sacrificing quality in the produced rotor blade.

According to a next further development of the invention, a separation plane for dividing the dividable manufacturing mold part is oriented approximately orthogonally to the separation plane for dividing the manufacturing mold parts. Thereby, additionally a separation, in particular, complete or in sections, can be provided as with the cited, known manufacturing mold. The second separation plane also can therefore extend substantially in the longitudinal direction of the rotor blade. However, a transverse separation of the manufacturing mold and of the rotor blade is also conceivable. In a preferred embodiment of the manufacturing mold according to the invention, the manufacturing mold can be divided into two manufacturing mold parts, each of which, on their own, can be divided again so that the rotor blade profile to be manufactured therein appears approximately quartered.

At least two manufacturing mold parts, that can be separated from each other, can remain connected together by means of a type of joint, in order to facilitate the closing of the form.

Another further development of the invention is characterized in that one of the manufacturing mold parts, despite the separation of the manufacturing mold, is designed and provided at least substantially for the design of an undivided profile leading edge. This way, a problem of known manufacturing molds is advantageously avoided, namely that the manufacturing mold cannot be closed sufficiently precisely flush, consequently, in these areas the profile segments are not connected sufficiently precisely flush, and as a result aerodynamics or durability problems occur in these areas in the produced rotor blade.

In a further development of the manufacturing mold, at least one of the manufacturing mold parts has, for the continuation of its manufacturing mold, a mold supplement that can be mounted with a divided manufacturing mold and can be disassembled before combining the manufacturing mold so that profile regions can be manufactured seamlessly beyond the actual area of the manufacturing mold part, without preventing the closing of the manufacturing mold after the production.

According to a further development of the invention, the manufacturing mold can be divided in order to produce rotor blade parts in the manufacturing mold parts, and the manufacturing mold parts can be joined together again, preferably to the complete manufacturing mold, in order to connect rotor blade parts together, so that the rotor blade can be joined and assembled in the manufacturing mold.

For precise alignment of manufacturing mold parts on each other, or to each other, guide elements, especially, alignment pins, or similar items, can be provided. Manufacturing mold parts can be connectable to each other; in particular, they can be lockable.

In an additional further development of the invention, a working platform that facilitates filling the mold with material for the rotor blade to be produced, can be inserted advantageously between the manufacturing mold parts that are separated from each other. Preferably, a working platform that can be moved up and down is provided, preferably in the perpendicular separation region of two manufacturing mold parts. The working platform is preferably, at least temporarily, a component part of the manufacturing mold.

A method for producing a rotor blade having a manufacturing mold, preferably using a manufacturing mold according to the invention, that is characterized in an independent solution of the presented objective, in that the manufacturing mold is divided, rotor blade parts are produced in parts of the manufacturing mold, and the manufacturing mold is closed again in order to connect, preferably adhesively bond, the rotor blade parts to each other, is also claimed for independent protection.

Preferably, the rotor blade parts are produced with plastics technology, where preferably, the plastics technology uses at least one resin and at least one fiber fabric, in particular, a layer composed of glass fibers and or carbon fibers.

For producing the rotor blade, in particular, resin transfer molding (RTM) or resin infusion molding (RIM) can be used, in particular, vacuum assisted resin infusion (VAR) and/or lamination technology are used.

According to the invention, at least one pre-fabricated belt can be inserted into at least one part of the manufacturing mold, or parts of a divided belt can be inserted into at least two parts of the manufacturing mold.

Before closing the manufacturing mold, at least one bar or web could be introduced in at least one part of the manufacturing mold, wherein preferably for a form-locking arrangement of the web at a rotor blade part at least one receptacle can be provided for the bar, especially, the receptacle can be substantially formed approximately in the shape of a U-profiled rail. Advantageously a simple, prefabricated, and cost-effective plate element can be installed as a web.

Within the scope of the invention, a separation plane is understood to be, in particular, also a separation surface and/or an abutting surface that can be curved and/or straight. Here, the separation plane can also be curved in parts and straight in parts.

### BRIEF DESCRIPTION OF THE DRAWINGS

An exemplary embodiment of the invention from which further inventive features can also result, but to which the scope of the invention is not limited, is represented in the drawings. They show:

FIG. 1 a cross-section of an exemplary embodiment of a completely open, still empty manufacturing mold according to the invention,

FIG. 2 the cross-section according to FIG. 1 in which the manufacturing mold is partially filled with working material or material for the rotor blade to be produced, and

FIG. 3 the cross section with a closed manufacturing mold with a profile cross-section of a rotor blade in its interior.

### DETAILED DESCRIPTION OF THE INVENTION

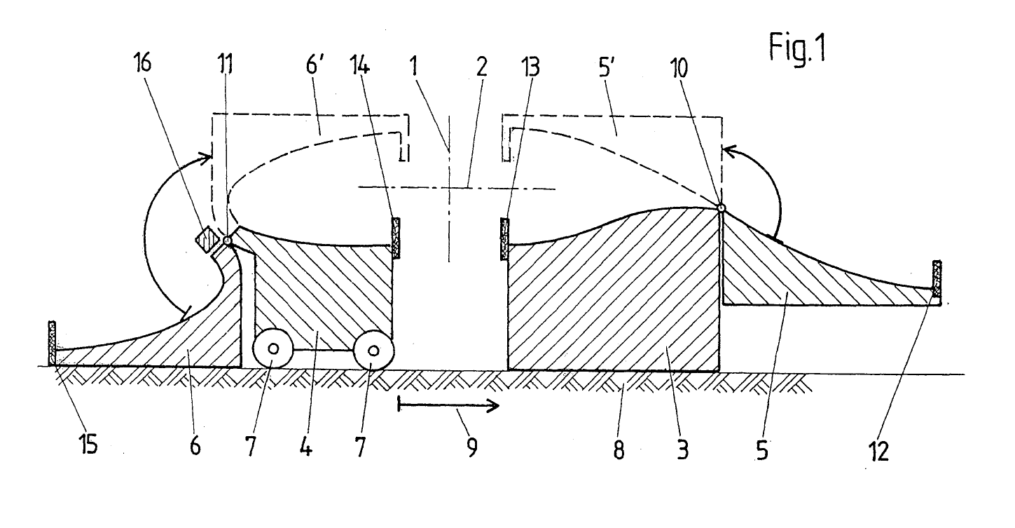

FIG. 1 shows a cross-section of an exemplary embodiment of a completely open, still empty manufacturing mold according to the invention.

The manufacturing mold is divided along two separation planes 1, 2 that are orthogonal to each other, each of which extends in the longitudinal direction of the manufacturing mold into and out of the drawing sheet, dividing its cross-section into four manufacturing mold parts 3 to 6. The manufacturing mold parts 3, 4 can be driven apart from each other for their separation shown in FIG. 1, using wheels 7 on the manufacturing mold part 4 on the ground 8, and can be driven back together in the direction of the arrow 9. Each of the further manufacturing mold parts 5 and 6 are arranged at the manufacturing mold parts 3, 4 in a manner so that they can be pivoted away using joints 10, 11. These manufacturing mold parts 5, 6 are shown in FIG. 1 in their open position and closed position, in which the cross-sectional profile of a rotor blade to be produced can be recognized, indicated with dashed lines 5′, 6′.

In addition, mold supplements 12 to 16 are arranged on the manufacturing mold parts 3 to 6, so that they can be put on and removed again before closing the manufacturing mold. In particular, mold supplement 16 serves to shape a seamless complete profile leading edge area of the rotor blade.

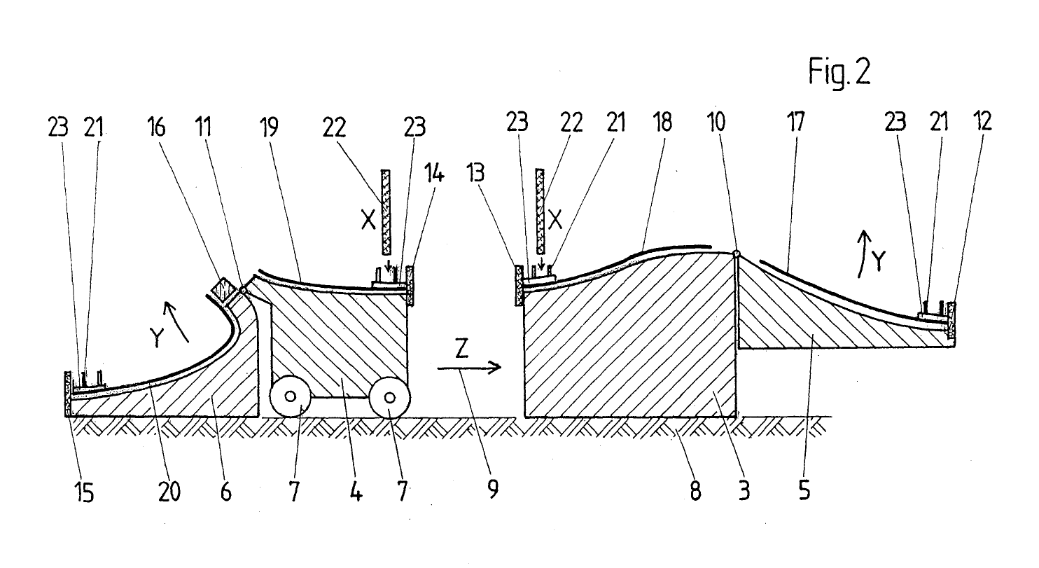

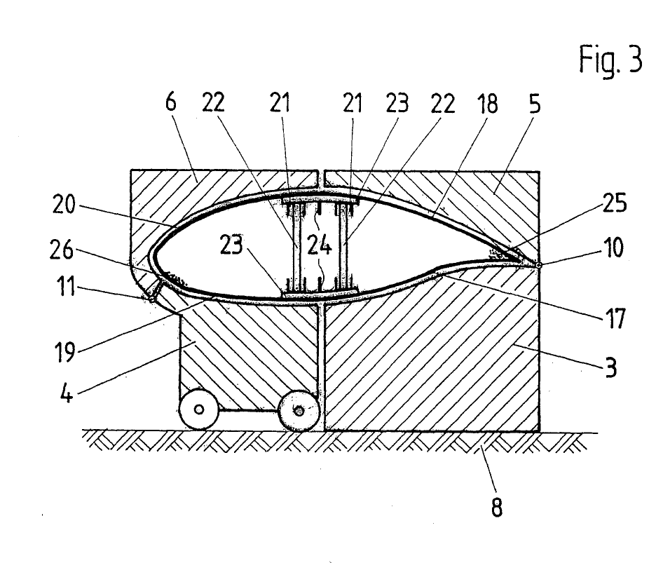

FIG. 2 shows the manufacturing mold from FIG. 1 in cross-section, already with some material for a rotor blade. Equivalent components are designated, as in FIG. 3, with the same reference numbers.

Shell parts 17 to 20 of a rotor blade, in particular, are already formed in the manufacturing mold parts 3 to 6. These can preferably be designed and formed by means of vacuum infusion using fiber fabrics and resin in the manufacturing mold parts 3 to 6. The introduction of fiber fabrics and the formation of vacuum chambers is facilitated by the division of the manufacturing mold according to the invention into manufacturing mold parts 3 to 6 that are easier to handle, likewise the handling of the rotor blade shell parts 17 to 20 is facilitated, in particular, in the case of a possible rejection of only one of the manufacturing mold parts 3 to 6. Naturally, the use of prefabricated or preconstructed parts, in particular so-called prepregs, in the manufacturing mold according to the invention and in the method according to the invention, is of course not excluded.

In addition, U-shaped receptacles 21 for webs 22 are disposed or formed in the shell parts 17 to 20, before closing of the manufacturing mold the webs 22 can simply be inserted therein and, for example, adhesively bonded. These receptacles 21 are located preferably at the belt parts 23 which were inserted in the manufacturing mold parts 17 to 20.

Letters X, Y, and Z symbolize the temporal sequence in which initially the webs 22 are inserted, then the manufacturing mold parts 5, 6 are shut, and finally the manufacturing mold parts 3, 4 are driven together.

FIG. 3 shows the closed manufacturing mold in which a profile cross-section of the rotor blade can be recognized. It is indicated (in an exaggerated manner) that the shell parts 18, 20 and 17, 19 are each bonded together via bonding lines 24, and the shell parts 17, 18 are bonded together with adhesive 25 for forming a profile trailing edge, and the shell parts 19, 20 are bonded together with adhesive 26 in the area of a formed profile leading edge.

1. A manufacturing mold for the production of a rotor blade for a wind turbine, the manufactured rotor blade having at least in a region of its longitudinal extension between a rotor blade root and a rotor blade tip, an aerodynamic cross-sectional profile that has a profile leading edge (nose) and a profile trailing edge, which are connected together via a suction side and a pressure side of the cross-sectional profile, the manufacturing mold comprising at least one separation plane that the manufacturing mold can be divided along, and which extends in the longitudinal direction of the rotor blade and between the profile leading edge and the profile trailing edge, with the simultaneous division of the suction side and the pressure side, into a manufacturing mold part for producing the rotor blade part comprising the profile leading edge and into a manufacturing mold part for producing a rotor blade profile part comprising the profile trailing edge.

2. The manufacturing mold according to claim 1, wherein the separation plane is oriented approximately perpendicularly.

3. The manufacturing mold according to claim 1, wherein at least one of the manufacturing mold parts itself can be divided.

4. The manufacturing mold according to claim 3, wherein a separation plane for dividing the dividable manufacturing mold part is oriented approximately orthogonally to the separation plane for dividing the manufacturing mold parts.

5. The manufacturing mold according to claim 3, wherein the manufacturing mold can be divided into two manufacturing mold parts, each of which on their own can be divided again so that the rotor blade profile to be manufactured therein appears approximately quartered.

6. The manufacturing mold according to claim 1, wherein at least two manufacturing mold parts that can be separated from each other remain connected together via a type of joint.

7. The manufacturing mold according to claim 3, wherein one of the manufacturing mold parts, despite division of the manufacturing mold, is designed and provided at least substantially for forming an undivided profile leading edge.

8. The manufacturing mold according to claim 1, wherein at least one of the manufacturing mold parts for continuation of its manufacturing mold has a mold supplement that can be mounted with a divided manufacturing mold and can be disassembled before joining the manufacturing mold.

9. The manufacturing mold according to claim 1, wherein the manufacturing mold can be divided in order to produce rotor blade parts in the manufacturing mold parts, and the manufacturing mold parts can be joined together again preferably to a complete manufacturing mold in order to connect rotor blade parts to each other.

10. The manufacturing mold according to claim 1, wherein guide elements, in particular, alignment pins or similar are provided for exact connection of the manufacturing mold parts on each other or to each other.

11. The manufacturing mold according to claim 1, wherein manufacturing mold parts are connectable to each other, and especially are lockable.

12. The manufacturing mold according to claim 1, wherein a working platform can be introduced between manufacturing mold parts separated from each other.

13. The manufacturing mold according to claim 12, wherein a working platform that can be moved up and down, is provided in the separation region of two manufacturing mold parts.

14. A method for producing a rotor blade using a manufacturing mold according to claim 1, comprising the steps of dividing the manufacturing mold, producing rotor blade parts in parts of the manufacturing mold, and closing the manufacturing mold again in order to adhesively bond, the rotor blade parts to each other.

15. The method according to claim 14, wherein the rotor blade parts are produced using plastics technology.

16. The method according to claim 15, wherein with plastics technology, at least one resin and at least one fiber layer composed of glass fibers and or carbon fibers are used.

17. The method according to claim 16, wherein resin transfer molding (RTM) is used.

18. The method according to claim 15, wherein resin infusion molding (RIM) is used, especially vacuum assisted resin infusion (VAR).

19. The method according to claim 15, wherein lamination technology is used.

20. The method according to claim 14, wherein at least one prefabricated belt is inserted in at least one part of the manufacturing mold.

21. The method according to claim 20, wherein parts of a divided belt are inserted in at least two parts of the manufacturing mold.

22. The method according to claim 14, wherein before closing the manufacturing mold, at least one bar is inserted in at least one part of the manufacturing mold.

23. The method according to claim 22, wherein for a form-locking arrangement of the bar at a rotor blade part, at least one receptacle is provided for the bar.

24. The method according to claim 23, wherein the receptacle is formed substantially in approximately the shape of a U-profiled rail.

25. The method according to claim 20, wherein a simple, prefabricated plate element is inserted as a bar.
